(19) United States
(12) Patent Application Publication
(10) Pub. No.: US 2026/0299552 A1
(43) Pub. Date: Oct. 1, 2026

(54) APPLICATION CHECK DEVICE AND APPLICATION CHECK METHOD FOR ADJUSTMENT RESULT

(71) Applicant: FANUC CORPORATION, Yamanashi (JP)

(72) Inventor: Yao LIANG, Yamanashi (JP)

(21) Appl. No.: 19/490,104

(22) PCT Filed: Jul. 10, 2023
(86) PCT No.: PCT/JP2023/025458

§ 371 Date: Dec. 4, 2025

(51) Int. Cl. G05B 19/4065

(52) U.S. Cl. CPC G05B 19/4065; G05B 2219/34465

(57) ABSTRACT

An adjustment result application check device includes a first information acquisition unit that acquires an adjusted first control parameter of a first motor control unit that drives a shaft of a first machine, and a second information acquisition unit that acquires a preset second control parameter of a second motor control unit that drives a shaft of a second machine, and a first frequency response of the second machine when operated using the second control parameter. The device also includes a frequency response prediction unit that predicts a second frequency response of the second machine when the first control parameter is applied to the second motor control unit based on the first and second control parameters and the first frequency response, and an adjustment result application check unit that checks whether the first control parameter is appliable to the second motor control unit using at least the second frequency response.

### TECHNICAL FIELD

The present disclosure relates to an application check device and an application check method for adjustment result, and particularly relates to an application check device and an application check method for adjustment result for, when there are a plurality of machines that are identical in model, allowing a first machine among the plurality of machines that are identical in model to undergo an adjustment, and checking whether or not a result of the adjustment is applicable to a second machine among the plurality of machines that are identical in model.

### BACKGROUND ART

Patent Document 1 describes a machine tool and a diagnosis method with which a frequency response of the machine tool is measured, and whether or not there is an abnormality in the machine tool is determined, and Patent Document 2 describes a frequency response prediction device and a frequency response prediction method with which a frequency response of a machine tool or an industrial machine is predicted.

Specifically, Patent Document 1 describes that the machine tool controls a first motor and a second motor to use a predetermined drive operation to drive each of a first movable part and a second movable part to each of a plurality of orientation positions. It is also described that the machine tool then acquires a frequency response of at least one of the first motor or the second motor in each of occasions including an occasion when each of the first movable part and the second movable part is positioned at each of the plurality of orientation positions, compares each of the frequency responses with a corresponding normative frequency response, and determines whether or not there is an abnormality in the machine tool based on a result of the comparison.

Furthermore, Patent Document 2 describes that the frequency response prediction device includes: a motor control unit that moves an axis of a machine tool or an industrial machine; a movement command generation unit that outputs, to the motor control unit, a movement command for changing a position of the axis from a first position to a second position; a frequency responses measurement unit that measures a frequency response of the machine tool or the industrial machine at each of the first position and the second position; a state switching unit that switches a state of the motor control unit at the first position; and a frequency responses prediction unit that predicts a frequency response of the machine tool or the industrial machine at the second position, in which the frequency responses measurement unit measures, at the first position, a plurality of frequency responses f1 regarding a plurality of states that the state switching unit switches, and measures, at the second position, a frequency response f2 regarding at least one state among the plurality of states, and the frequency responses prediction unit uses the plurality of frequency responses f1 and the frequency response f2 to predict a frequency response f3 regarding another state than the at least one state among the plurality of states at the second position.

### CITATION LIST

### Patent Document

Patent Document 1: PCT International Publication No. WO2022/113966
Patent Document 2: Japanese Patent No. 7022261

### DISCLOSURE OF THE INVENTION

### Problems to be Solved by the Invention

It has been desired, when there are a plurality of machines that are identical in model, to adjust a control parameter of a first machine among the plurality of machines that are identical in model, to apply a result of the adjustment to a second machine among the plurality of machines that are identical in model, and to eliminate efforts for adjusting the control parameter of the second machine that is identical in model. When a result of an adjustment of the control parameter of the first machine is applied as is to the second machine that is identical in model, however, some issues may arise such as occurrence of vibration or a narrowed control band for the machine due to variation, for example, in manufacturing or assembly among the plurality of machines that are identical in model.

Therefore, an application check device and an application check method for adjustment result for making it possible to check whether or not, before a result of an adjustment of a first machine is applied to a second machine that is identical in model, the result of the adjustment is applicable to the second machine has been desired.

### Means for Solving the Problems

A representative first aspect of the present disclosure is an application check device for adjustment result, including: a first information acquisition unit that acquires a first control parameter, the first control parameter having been adjusted, of a first motor control unit that drives an axis of a first machine; a second information acquisition unit that acquires a second control parameter, the second control parameter being set in advance, of a second motor control unit that drives an axis of a second machine that is identical in model to the first machine and a first frequency response of the second machine when operated using the second control parameter; a frequency responses prediction unit that predicts a second frequency response of the second machine in a case where the first control parameter is applied to the second motor control unit of the second machine based on the first control parameter, the second control parameter, and the first frequency response; and an adjustment result application check unit that checks whether or not the first control parameter is applicable to the second motor control unit of the second machine using at least the second frequency response.

A representative second aspect of the present disclosure is an application check method for adjustment result, including causing a computer to execute: processing of acquiring a first control parameter, the first control parameter having been adjusted, of a first motor control unit that drives an axis of a first machine; processing of acquiring a second control parameter, the second control parameter being set in advance, of a second motor control unit that drives an axis of a second machine that is identical in model to the first machine and a first frequency response of the second machine when operated using the second control parameter; processing of predicting a second frequency response of the second machine in a case where the first control parameter is applied to the second motor control unit of the second machine based on the first control parameter, the second control parameter, and the first frequency response; and processing of checking whether or not the first control parameter is applicable to the second motor control unit of the second machine using at least the second frequency response.

### BRIEF DESCRIPTION OF THE DRAWINGS

FIG. 1 is a block diagram illustrating a configuration of an application check device for adjustment result, according to a first embodiment of the present disclosure.

FIG. 2 is a block diagram illustrating an example of a configuration of a representative machine.

FIG. 3 is a block diagram illustrating an example of a configuration of a same model machine.

FIG. 4 is a Bode diagram illustrating an example of a phase margin, a gain margin, and a maximum gain of a closed loop characteristic.

FIG. 5 is a flowchart illustrating operation of the application check device according to the first embodiment.

FIG. 6 is a block diagram illustrating a configuration of an application check device for adjustment result, according to a second embodiment of the present disclosure.

FIG. 7 is a block diagram illustrating a configuration of an application check device for adjustment result, according to a third embodiment of the present disclosure.

FIG. 8 is a flowchart illustrating operation of the application check device according to the third embodiment.

FIG. 9 is a block diagram illustrating a configuration of an application check device for adjustment result, according to a fourth embodiment of the present disclosure.

### PREFERRED MODE FOR CARRYING OUT THE INVENTION

Embodiments of the present disclosure will now be described herein in detail with reference to the accompanying drawings.

### First Embodiment

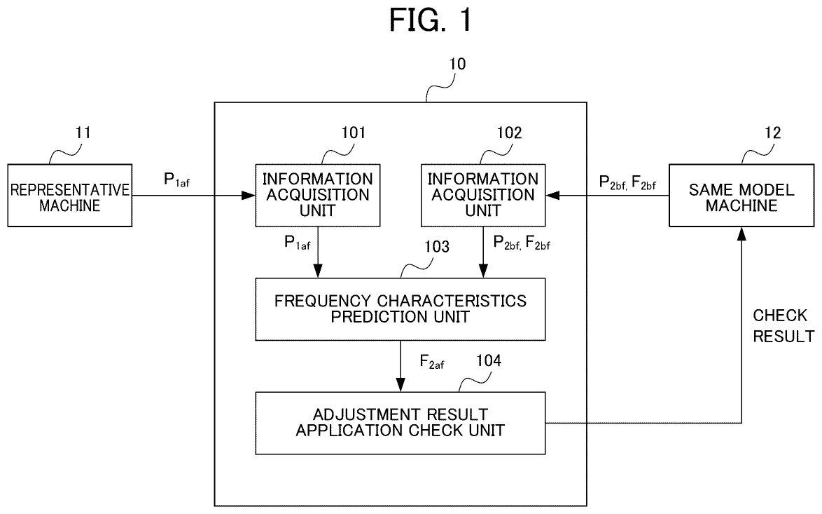

FIG. 1 is a block diagram illustrating a configuration of an application check device for adjustment result, according to a first embodiment of the present disclosure. As illustrated in FIG. 1, a representative machine 11 and a machine 12 (hereinafter referred to as a same model machine) that is identical in model to the representative machine 11 are coupled to an application check device 10 for adjustment result. The representative machine 11 serves as a first machine, and the same model machine 12 serves as a second machine that is identical in model to the first machine.

Although FIG. 1 illustrates one same model machine 12, two or more same model machines 12 may be coupled to the application check device 10 for adjustment result. When there are a plurality of machines that are identical in model, a desired one among the machines is selected as the representative machine 11, and the remaining machines that are identical in model serve as the same model machines 12. The representative machine 11 and the same model machine 12 are, for example, machine tools, robots, or industrial machines each including a motor control unit for controlling a motor. The motor control unit includes a controller including, for example, a speed control unit, a current control unit, or a filter. The representative machine 11, as a control parameter of the controller is adjusted for allowing a frequency response of the representative machine 11 to reach a desired frequency response, outputs a control parameter P_{1af} that has been adjusted to the application check device 10. The control parameter P_{1af} serves as a first control parameter. When it is simply referred to as a “frequency response” in the present specification, the “frequency response” includes a frequency response of a gain and a frequency response of a phase lag.

The same model machine 12 outputs, to the application check device 10, a control parameter P_{2bf} that has been set in advance of the controller and a frequency response F_{2bf} of the same model machine 12, which has been measured after the motor control unit has been operated using the control parameter P_{2bf}. The control parameter P_{2bf} serves as a second control parameter, and the frequency response F_{2bf} serves as a first frequency response of the second machine. When there are two or more same model machines 12 in number, control parameters P_{2bf} that are identical to each other may be set or control parameters P_{2bf} that are not identical to each other may be set in the controller of the same model machines 12. The frequency responses F_{2bf} that the two or more same model machines 12 output may sometimes differ from each other due to variation, for example, in manufacturing or assembly among the two or more same model machines 12.

The application check device 10 predicts a frequency response F_{2af} of the same model machine 12 in a case where the control parameter P_{1af} of the controller of the representative machine 11 is applied as the control parameter of the controller of the same model machine 12 based on the control parameter P_{1af} that the representative machine 11 has outputted and the control parameter P_{2bf} and the frequency response F_{2bf} that the same model machine 12 has outputted. The frequency response F_{2af} serves as a second frequency response of the second machine. Then, the application check device 10 checks whether or not the control parameter P_{1af} of the representative machine 11 is applicable to the same model machine 12 based on the frequency response F_{2af} of the same model machine 12, which has been predicted, and outputs a result of the check to the same model machine 12. Detailed configurations of the representative machine 11, the same model machine 12, and the application check device 10 will now be described herein.

### (Representative Machine 11)

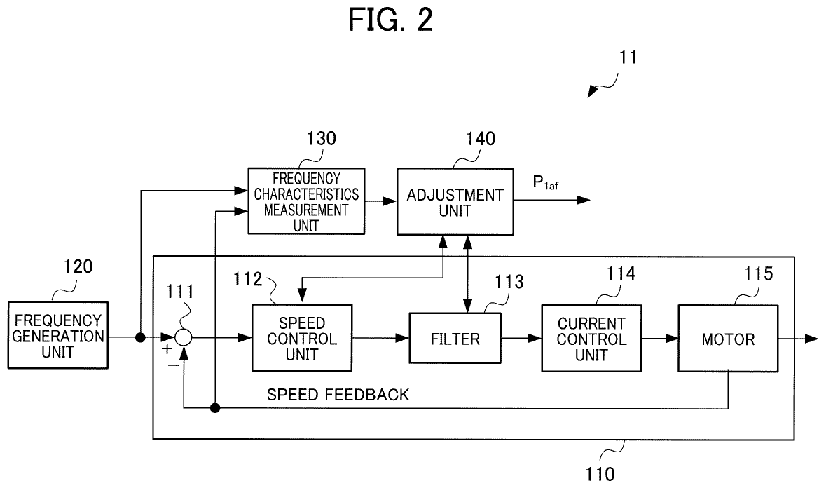

FIG. 2 is a block diagram illustrating an example of the configuration of the representative machine. As illustrated in FIG. 2, the representative machine 11 includes a motor control unit 110, a frequency generation unit 120, a frequency responses measurement unit 130, and an adjustment unit 140. The motor control unit 110 of the representative machine 11 serves as a first motor control unit that drives an axis of the first machine. One or more of the frequency generation unit 120, the frequency responses measurement unit 130, and the adjustment unit 140 may be provided in the motor control unit 110. The frequency responses measurement unit 130 may be provided in the adjustment unit 140. The frequency responses measurement unit 130 may be provided in the application check device 10. Components of the motor control unit 110, the frequency generation unit 120, the frequency responses measurement unit 130, and the adjustment unit 140 will now be described herein.

The motor control unit 110 includes a subtracter 111, a speed control unit 112, a filter 113, a current control unit 114, and a motor 115. The speed control unit 112, the filter 113, and the current control unit 114 all configure a controller. As the motor 115, it is possible to use a linear motor that performs linear motions or a motor having a rotation axis, for example. A target to be driven by the motor 115 is, for example, a mechanical part of a machine (an axis of a machine, for example) such as a machine tool, a robot, or an industrial machine.

The subtracter 111 acquires a difference (serving as a speed error) between a speed command that has been inputted and a detected speed that has been provided as speed feedback, and outputs the acquired difference to the speed control unit 112. The speed control unit 112 adds a value acquired by integrating a product of the speed error and an integration gain K1v and a value of a product of the speed error and a proportional gain K2v, and outputs the acquired value to the filter 113 as a torque command. The integration gain K1v and the proportional gain K2v serve as control parameters of the speed control unit 112. Mathematical Equation 1 (hereinafter referred to as Equation 1) represents a transfer function G_{V}(s) of the speed control unit 112.

$${G}_{V} ( s ) = \frac{K 1 v}{s} + k 2 v \qquad [ Mathematical Equation 1 ]$$

The filter 113 is a filter for attenuating a certain frequency component, and, for example, a notch filter, a low-pass filter, or a band-stop filter is used. An output of the filter 113 is outputted as a torque command to the current control unit 114. Mathematical Equation 2 (hereinafter referred to as Equation 2) represents a transfer function G_{F}(s) of a notch filter serving as the filter 113. Coefficients ω_{c}, τ, and δ serve as control parameters of the filter 113. In Mathematical Equation 2, the coefficient δ represents an attenuation coefficient, the coefficient ω_{c} represents a center angle frequency, and the coefficient τ represents a fractional bandwidth. When a center frequency is represented by f_{c}, and a bandwidth is represented by f_{w}, the coefficient ω_{c} is represented by ω_{c}=2nf_{c}, and the coefficient τ is represented by τ=f_{w}/f_{c}.

$${G}_{F} ( s ) = \frac{{s}^{2} + 2 δ τ {ω}_{c} s + {ω}_{c}^{2}}{{s}^{2} + 2 τ {ω}_{c} s + {ω}_{c}^{2}} \qquad [ Mathematical Equation 2 ]$$

The current control unit 114 generates a current command for driving the motor 115 based on the torque command, and outputs the generated current command to the motor 115. When the motor 115 is a linear motor, a position of a movable part is detected by a linear scale (not shown), the detected position is then differentiated to acquire a detected speed, and the acquired detected speed is inputted into the subtracter 111 as speed feedback. When the motor 115 is a motor having a rotation axis, a rotation angle position is detected by a rotary encoder (not shown), and a detected speed is then inputted into the subtracter 111 as speed feedback.

The frequency generation unit 120 outputs a sinusoidal signal, while sequentially changing a frequency, as a speed command, to the subtracter 111 of the motor control unit 110 and the frequency responses measurement unit 130.

The frequency responses measurement unit 130 uses the speed command (sine wave) that serves as an input signal generated by the frequency generation unit 120, and the detected speed (sine wave) that serves as an output signal outputted from the rotary encoder (not shown) provided in the motor 115 or the differentiation (sine wave) of the detected position that serves as an output signal outputted from the linear scale, acquires, for each frequency designated by the speed command, a frequency response of an amplitude ratio (input/output gain) between the input signal and the output signal and a frequency response of a phase lag, and outputs the frequency responses to the adjustment unit 140. The frequency responses that have been acquired represent a closed loop frequency response Pc. Furthermore, the frequency responses measurement unit 130 calculates an opened loop frequency response Po from the frequency response Pc, and outputs the calculated frequency response to the adjustment unit 140. By using the opened loop frequency response Po, the closed loop frequency response Pc is indicated as Pc=Po/(1+Po). Therefore, it is possible to use Po=Pc/(1□Pc) to acquire the opened loop frequency response Po.

The integration gain K1v and the proportional gain K2v of the speed control unit 112 and the coefficients ω_{c}, τ, and δ of the transfer function of the filter 113, which serve as control parameters, have been set in advance. The adjustment unit 140 uses the opened loop frequency response Po or the opened loop frequency response Po, adjusts, among the control parameters that have been set in advance, one gain or both gains, that is, one or both of the integration gain K1v and the proportional gain K2v of the speed control unit 112 and at least one (serving as the control parameter P_{1af}) of the coefficients ω_{c}, τ, or δ of the transfer function of the filter 113, and acquires an optimum value. The adjustment unit 140 outputs, as a result of the adjustment, an optimized control parameter (adjusted control parameter) P_{1af} serving as the first control parameter to the application check device 10. In here, the adjusted control parameter may not be necessarily an optimized control parameter, and a control parameter that has been adjusted from a control parameter that has been set in advance may be suffice.

A method for using a frequency response to acquire an optimum value of a control parameter is not particularly limited, but is described in Japanese Unexamined Patent Application Publication No. 2020-057211, for example. Japanese Unexamined Patent Application Publication No. 2020-057211 describes that a machine learning device optimizes a coefficient of a filter based on measurement information of a measurement device that measures at least one of an input/output gain of a servo control device or a phase lag in input/output based on an input signal and an output signal that change in frequency in the servo control device. Although, in Japanese Unexamined Patent Application Publication No. 2020-057211, the measurement information is an actually-measured value, WO 2021/251226, for example, describes an example where estimation values of frequency responses of an input/output gain and a phase lag of a motor control unit are acquired, the estimation values are used to set control parameters (the integration gain K1v and the proportional gain K2v and the coefficients ω_{c}, τ, and δ of the transfer function of the filter 113) of the motor control unit to optimum values, and the estimated frequency responses may be used to acquire the optimum values of the control parameters.

### (Same Model Machine 12)

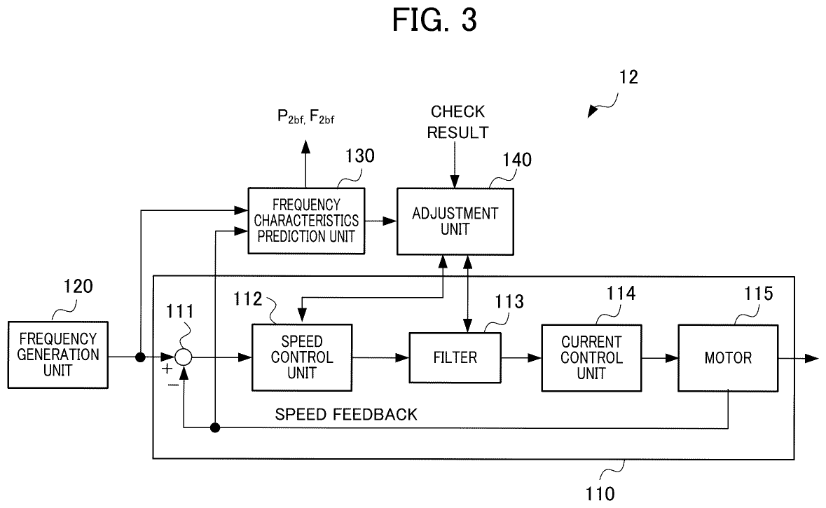

FIG. 3 is a block diagram illustrating an example of a configuration of the same model machine. As illustrated in FIG. 3, the same model machine 12 has the configuration identical to the configuration of the representative machine 11 illustrated in FIG. 2. In FIG. 3, like reference numerals designate identical components of the same model machine 12 to the components of the representative machine 11 illustrated in FIG. 2. The motor control unit 110 of the same model machine 12 serves as a second motor control unit that drives an axis of the second machine. The frequency responses measurement unit 130 of the same model machine 12 may be provided in the application check device 10. In the same model machine 12, the frequency responses measurement unit 130 and the adjustment unit 140 differ in operation from that in the representative machine 11.

Operation of the same model machine 12, which differs from that in the representative machine 11, will now be described herein. The integration gain K1v and the proportional gain K2v of the speed control unit 112 and the coefficients ω_{c}, τ, and δ of the transfer function of the filter 113 of the same model machine 12 have been set in advance to values identical to those of the control parameters, which have not yet been adjusted, of the representative machine 11. The integration gain K1v and the proportional gain K2v and the coefficients ω_{c}, τ, and δ, which have been set in advance and which serve as the control parameters, are stored in the frequency responses measurement unit 130 of the same model machine 12.

In the same model machine 12, the frequency responses measurement unit 130 uses the speed command (sine wave) that serves as an input signal generated by the frequency generation unit 120 and the detected speed (sine wave) that serves as an output signal outputted from the rotary encoder (not shown) provided in the motor 115 or the differentiation (sine wave) of the detected position that serves as an output signal outputted from the linear scale, acquires, for each frequency designated by the speed command, a frequency response F_{2bf} of an amplitude ratio (input/output gain) between the input signal and the output signal and a phase lag. The frequency response F_{2bf} represents a frequency response acquired as the motor control unit 110 operates using the control parameters that have been set in advance. The frequency responses measurement unit 130 outputs the control parameter P_{2bf} that corresponds to the control parameter Piaf serving as the first control parameter (control parameter that has been adjusted) and that serves as a second control parameter and the frequency response F_{2bf} to the application check device 10. The control parameter P_{2bf} corresponds to, when the control parameter P_{1af} corresponds to the coefficients ω_{c}, τ, and δ of the transfer function of the filter 113, for example, the coefficients ω_{c}, τ, and δ of the transfer function of the filter 113 among the integration gain K1v and the proportional gain K2v and the coefficients ω_{c}, τ, and δ, which are stored in the frequency responses measurement unit 130.

Although, when there are two or more same model machines 12 in number, control parameters that have been set in advance of the controller of each of the same model machines 12 may be set to identical control parameters, frequency responses of the plurality of same model machines 12, which have been measured, may sometimes differ from each other due to variation, for example, in manufacturing or assembly among the machines.

When the application check device 10 has determined that the control parameter P_{1af} of the representative machine 11 is applicable to the same model machine 12, the adjustment unit 140 of the same model machine 12 receives a result of the determination, which indicates applicability, and the control parameter P_{1af} (which serves as a result of the check illustrated in FIG. 3) from the application check device 10. Then, the adjustment unit 140 of the same model machine 12 sets the control parameter P_{1af} in the motor control unit 110.

When the application check device 10 has determined that the control parameter P_{1af} of the representative machine 11 is not applicable to the same model machine 12, on the other hand, the adjustment unit 140 of the same model machine 12 receives a result of the determination, which indicates non-applicability (which serves as a result of the check illustrated in FIG. 3) from the application check device 10. Then, the adjustment unit 140 of the same model machine 12 acquires an optimum value of a control parameter, similar to the representative machine 11.

### (Application Check Device 10)

As illustrated in FIG. 1, the application check device 10 includes an information acquisition unit 101, an information acquisition unit 102, a frequency responses prediction unit 103, and an adjustment result application check unit 104. The information acquisition unit 101 serves as a first information acquisition unit, and the information acquisition unit 102 serves as a second information acquisition unit. The information acquisition unit 101 acquires the control parameter P_{1af} from the adjustment unit 140 of the representative machine 11. The control parameter P_{1af} represents a control parameter acquired as a result of an adjustment. The information acquisition unit 102 acquires the control parameter P_{2bf} and the frequency response F_{2bf} from the frequency responses measurement unit 130 of the same model machine 12. The control parameter P_{2bf} represents a control parameter that has been set in advance. The frequency responses prediction unit 103 uses the control parameter P_{1af} acquired by the information acquisition unit 101 to calculate a frequency response C_{1af} of the controller of the representative machine 11.

As a method for using the control parameter P_{1af} to calculate the frequency response C_{1af} of the controller of the representative machine 11, there is a method for acquiring a frequency response from a transfer function. For example, it is possible to acquire a frequency response of the filter 113 configuring the controller from a transfer function on a right side of Mathematical Equation 3. Such a piece of software that makes it possible to analyze a frequency response from a transfer function is known, and it is possible to use those pieces of software available from those indicated by, for example,
https://jp.mathworks.com/help/signal/ug/frequency~renponse.html,
https://jp.mathworks.com/help/signal/ref/freqz.html,
https://docs.scipy.org/doc/scipy-0.19.1/reference/generated/scipy.signal.freqz.html, and
https://wiki.octave.org/Control_package.

Furthermore, the frequency responses prediction unit 103 uses the control parameter P_{2bf} acquired by the information acquisition unit 102 to calculate the frequency response C_{2bf} of the controller of the same model machine 12. It is possible to acquire the frequency response C_{2bf} using a method identical or similar to that for acquiring the frequency response C_{1af}.

The frequency response C_{2af} of the controller of the same model machine 12, when the control parameter P_{1af} of the representative machine 11 is applied as the control parameter of the controller of the same model machine 12, is identical to the frequency response C_{1af} (C_{2af}=C_{1af}). One reason of the sameness is that the controllers that are identical to each other in type are used in the representative machine 11 and the same model machine 12, and, when the control parameters are identical to each other, the frequency responses of the controllers are also identical to each other. For example, when the representative machine 11 and the same model machine 12 use the filters 113 that are identical to each other in type and when the coefficients ω_{c}, τ, and δ of the filters 113, which serve as the control parameters, are identical to each other, the frequency responses of the filter 113 are also identical to each other.

The frequency responses prediction unit 103 uses Mathematical Equation 3 (hereinafter referred to as Equation 3) to acquire the frequency response F_{2af} of the same model machine 12 when the control parameter P_{1af} of the representative machine 11 is applied as the control parameter of the controller of the same model machine 12.

$${F}_{2 af} = {F}_{2 bf} + {C}_{2 af} + {C}_{2 bf} \qquad [ Mathematical Equation 3 ]$$

One reason of why the frequency response F_{2bf} serving as the first frequency response changes to the frequency response F_{2af} serving as the second frequency response in the same model machine 12 is that the control parameter P_{2bf} of the controller of the same model machine 12 has been changed to the control parameter P_{1af}. The frequency responses prediction unit 103 makes it possible to add, as illustrated in Mathematical Equation 3, a difference (C_{2af}−C_{2bf}) between the frequency response C_{2af} of the controller of the same model machine 12 and the frequency response C_{2bf} of the controller of the same model machine 12 to the frequency response F_{2bf} to predict the frequency response F_{2af}. Note that a difference between “frequency responses” includes a difference between frequency responses of gains and a difference between frequency responses of phase lags.

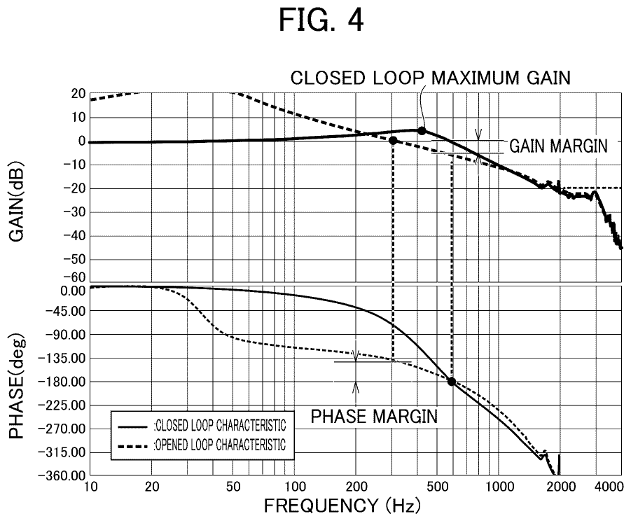

The adjustment result application check unit 104 checks whether or not the control parameter P_{1af} representing a result of the adjustment of the representative machine 11 is applicable to the same model machine 12 based on the frequency response F_{2af} serving as a result of the prediction. The adjustment result application check unit 104 calculates a phase margin, a gain margin, and a closed loop maximum gain, for example, based on the frequency response F_{2af} to determine stability. The phase margin and the gain margin are calculated from an opened loop phase characteristic and an opened loop gain characteristic, and the closed loop maximum gain is calculated from a closed loop gain characteristic. FIG. 4 is a Bode diagram illustrating an example of a phase margin, a gain margin, and a maximum gain of a closed loop characteristic. For example, the adjustment result application check unit 104 provides a phase margin of 30 degrees, a gain margin of 6 dB, and a closed loop maximum gain of 5 dB as evaluation criteria for stability, and, when the calculated phase margin and the calculated gain margin are greater than the evaluation criteria for the margins, respectively, and the closed loop characteristic maximum gain is smaller than the evaluation criterion, determines that stability is secured. The evaluation criteria indicate mere examples, and other values may be used as the evaluation criteria for stability. The adjustment result application check unit 104 may determine responsiveness instead of stability. For example, when the calculated phase margin and the calculated gain margin are smaller than the phase margin of 30 degrees and the gain margin of 6 dB, which serve as evaluation criteria for responsiveness, respectively, and the calculated closed loop maximum gain is greater than 5 dB, responsiveness is determined to be superior.

The adjustment result application check unit 104 uses a result of the determination to determine whether or not to apply the control parameter P_{1af} of the representative machine 11 to the same model machine 12. For example, to apply the control parameter P_{1af} of the representative machine 11 to the same model machine 12 when stability has been determined, the adjustment result application check unit 104 outputs a result of the determination, which indicates applicability, and the control parameter P_{1af} to the adjustment unit 140 of the same model machine 12 as a result of the check.

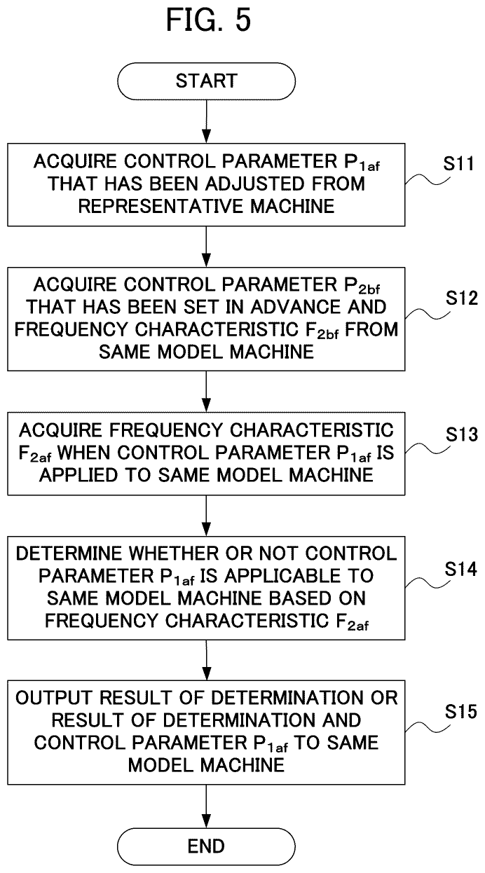

When no stability has been determined, on the other hand, the adjustment result application check unit 104 outputs a result of the determination, which indicates that the control parameter P_{1af} of the representative machine 11 is not applicable to the same model machine 12 to the adjustment unit 140 of the same model machine 12 as a result of the check. Next, operation of the application check device 10 according to the present embodiment will now be described herein with reference to a flowchart illustrated in FIG. 5.

At Step S11, the information acquisition unit 101 acquires the control parameter P_{1af} that has been adjusted from the adjustment unit 140 of the representative machine 11.

At Step S12, the information acquisition unit 102 acquires the control parameter P_{2bf} that has been set in advance and the frequency response F_{2bf} of the same model machine 12 from the frequency responses measurement unit 130 of the same model machine 12.

At Step S13, the frequency responses prediction unit 103 acquires the frequency response F_{2af} when the control parameter P_{1af} is applied to the same model machine 12. It is possible to acquire the frequency response F_{2af} by using Mathematical Equation 3 as described already.

At Step S14, the adjustment result application check unit 104 determines whether or not the result of the adjustment of the representative machine 11 is applicable to the same model machine 12 based on the frequency response F_{2af} serving as a result of the prediction.

In the present embodiment, as described already, the adjustment result application check unit 104 calculates a phase margin, a gain margin, and a closed loop maximum gain, for example, based on the frequency response F_{2af} to determine stability.

At Step S15, the adjustment result application check unit 104 outputs a result of the determination or the result of the determination and the control parameter P_{1af} to the same model machine 12 as a result of the check.

According to the present embodiment described above, it is possible to check whether or not a result of an adjustment of a representative machine is applicable before being applied to another machine that is identical in model. In addition, according to the present embodiment, stability between the representative machine and a machine that is identical in model, in which there is no occurrence of vibration, is guaranteed.

### Second Embodiment

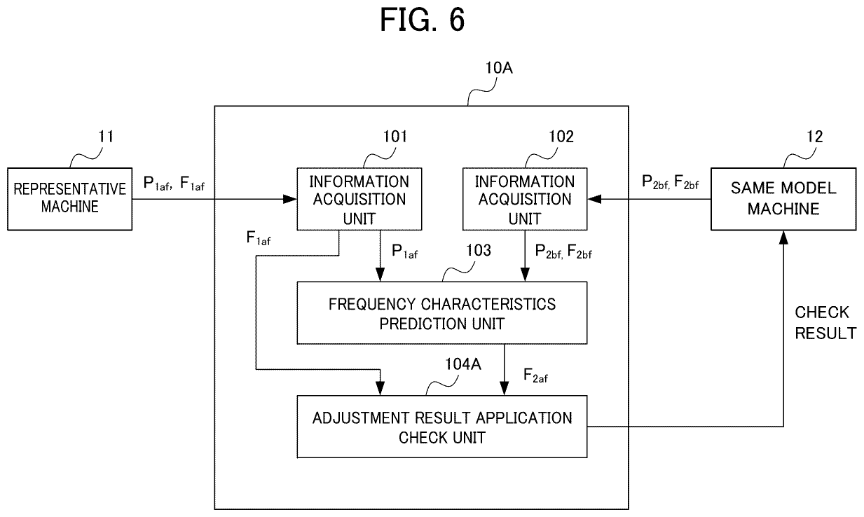

FIG. 6 is a block diagram illustrating a configuration of an application check device for adjustment result, according to a second embodiment of the present disclosure. In FIG. 6, like reference numerals designate identical components to the components illustrated in FIG. 1. In an application check device 10A according to the present embodiment, as illustrated in FIG. 6, the adjustment result application check unit 104 of the application check device 10 according to the first embodiment has been replaced with an adjustment result application check unit 104A.

The information acquisition unit 101 acquires the control parameter P_{1af} and the frequency response F_{1af} of the representative machine 11 being operated using the control parameter P_{1af} from the representative machine 11. The frequency response F_{1af} serves as a third frequency response of the first machine. The adjustment result application check unit 104A acquires the frequency response Faf of the representative machine 11 from the information acquisition unit 101, and compares the frequency response F_{1af} and the frequency response F_{2af} calculated by the frequency responses prediction unit 103 with each other. The adjustment result application check unit 104A performs the comparison of the frequency response F_{2af} and the frequency response F_{1af} with each other (comparison of the second frequency response and the third frequency response with each other) by comparing control bands with each other, for example. A control band means a frequency at which a gain crosses a point of 0 dB or −3 dB. Then, the adjustment result application check unit 104A determines whether or not to apply the control parameter P_{1af} of the representative machine 11 to the same model machine 12 based on a result of the comparison.

To apply the control parameter P_{1af} of the representative machine 11 to the same model machine 12 when it is determined that the control band of the same model machine 12 is wider than the control band of the representative machine 11 or wider than 90% of the control band of the representative machine 11, for example, the adjustment result application check unit 104A outputs a result of the determination, which indicates applicability, and the control parameter P_{1af} to the adjustment unit 140 of the same model machine 12 as a result of the check.

When it is determined that the control band of the same model machine 12 is equal to or narrower than the control band of the representative machine 11 or equal to or narrower than 90% of the control band of the representative machine 11, for example, on the other hand, the adjustment result application check unit 104A outputs a result of the determination, which indicates that the control parameter P_{1af} of the representative machine 11 is not applicable to the same model machine 12 to the adjustment unit 140 of the same model machine 12 as a result of the check.

Operation of the application check device 10A according to the present embodiment differs, compared with the operation of the application check device 10 illustrated in FIG. 5, in those described below. At Step S11, the information acquisition unit 101 acquires the frequency response F_{1af} of the representative machine 11 in addition to the control parameter P_{1af} that has been adjusted from the adjustment unit 140 of the representative machine 11. At Step S14, the adjustment result application check unit 104A compares the frequency response F_{1af} of the representative machine 11 when operated using the control parameter P_{1af} with the frequency response F_{2af} calculated by the frequency responses prediction unit 103, and determines whether or not to apply the control parameter P_{1af} of the representative machine 11 to the same model machine 12 based on a result of the comparison.

According to the present embodiment described above, similar to the first embodiment, it is possible to check whether or not a result of an adjustment of a representative machine is applicable before being applied to another machine that is identical in model. In addition, according to the present embodiment, it is possible to guarantee, in the representative machine and a machine that is identical in model, a characteristic of a control band, for example, which is identical or similar to that of the representative machine having undergone an adjustment.

### Third Embodiment

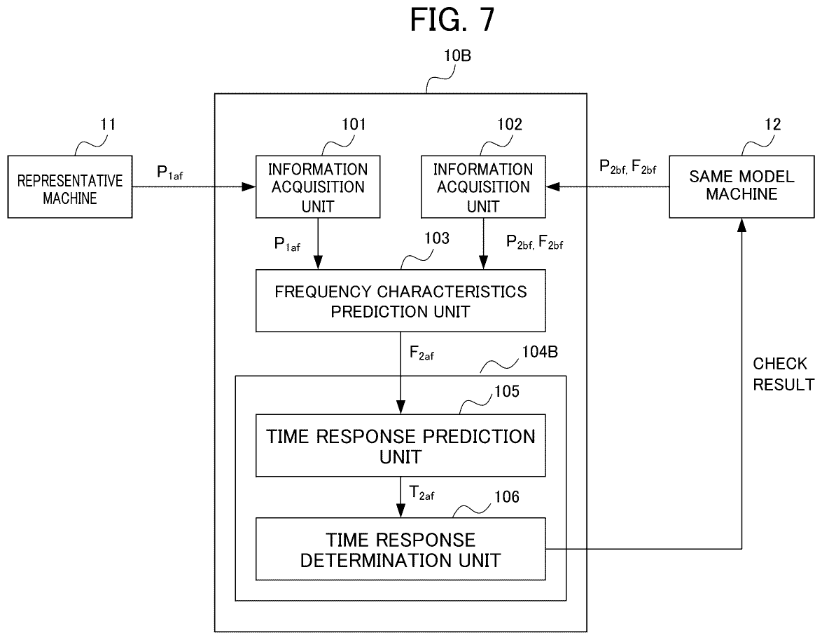

FIG. 7 is a block diagram illustrating a configuration of an application check device for adjustment result, according to a third embodiment of the present disclosure. In FIG. 7, like reference numerals designate identical components to the components illustrated in FIG. 1. In an application check device 10B according to the present embodiment, as illustrated in FIG. 7, the adjustment result application check unit 104 according to the first embodiment has been replaced with an adjustment result application check unit 104B. The adjustment result application check unit 104B includes a time response prediction unit 105 and a time response determination unit 106.

The time response prediction unit 105 utilizes the frequency response F_{2af} predicted by the frequency responses prediction unit 103 to predict a time response Traf. Examples of the time response include a step response when a step-shaped input is provided, an impulse response when an impulse-shaped input is provided, and a ramp response when an input is transitioned from a state where the input does not change to a state where the input changes at a constant speed.

In the method for utilizing the frequency response F_{2af} to predict the time response T_{2af}, the frequency response F_{2af} is used to perform a mode analysis to calculate a model T(s) of a transfer function. As the model T(s) of the transfer function is allowed to undergo inverse laplace transformation, the time response T_{2af}(t) is acquired. A method for utilizing a frequency response to predict a time response is described in Japanese Patent No. 6515844, for example.

An example method for utilizing a frequency response to predict a time response will now be described herein. The time response prediction unit 105 acquires the frequency response F_{2af} representing an opened loop frequency response or a closed loop frequency response from the frequency responses prediction unit 103, and performs a mode analysis. In the mode analysis, a number of mode vibrations ω of machine vibration and a mode damping ratio ζ are estimated from the frequency response.

For example, the mode analysis is used to calculate a model T(s) of a transfer function of Mathematical Equation 4 (Equation 4 described below). The model T(s) of the transfer function represents the transfer function of the same model machine 12 in a case of the control parameter Piaf. On a right side of Mathematical Equation 4, a first term represents a rigid body mode, and a second term represents a resonance mode. A number of vibrations and a damping ratio of an n-th mode are represented by ωn and ζn, respectively. Coefficients are represented by K₀ and Kₙ, respectively.

$$T ( s ) = \frac{{K}_{0}}{{s}^{2}} + {\sum }_{n} \frac{{ω}_{n}^{2} / {K}_{n}}{{s}^{2} + 2 {ζ}_{n} {ω}_{n} s + {ω}_{n}^{2}} \qquad [ Mathematical Equation 4 ]$$

Next, a main component analysis is performed to acquire a model T(s)′ of a transfer function of Mathematical Equation 5 (Equation 5 described below). In the main component analysis, a main (dominant) mode is only extracted from among a plurality of modes acquired through the mode analysis.

$${T ( s )}^{′} = \frac{{K}_{0}}{{s}^{2}} + \frac{{ω}_{1}^{2} / {K}_{1}}{{s}^{2} + 2 {ζ}_{1} {ω}_{1} s + {ω}_{1}^{2}} \qquad [ Mathematical Equation 5 ]$$

Mathematical Equation 4 and Mathematical Equation 5 described above serve as models of a machine when the rigid body mode and a first resonance mode are only taken into account. Therefore, it is possible to use a model with a minimum degree of freedom (mode) to express a characteristic of the machine.

In addition, as Mathematical Equation 5 described above is allowed to undergo inverse laplace transformation, a time response T_{2af}(t) of Mathematical Equation 6 (Equation 6 described below) is acquired. The time response T_{2af}(t) represents a time response of the same model machine 12 in a case of the control parameter P_{1af}.

$${T}_{2 af} ( t ) = \frac{1}{2 π i} + {\int }_{σ - i ∞}^{σ + i ∞} {T ( s )}^{′} {e}^{st} ds$$

The time response determination unit 106 acquires the time response T_{2af}(t) from the time response prediction unit 105, and determines whether or not a result of the adjustment of the representative machine 11 is applicable to the same model machine 12 based on the time response T_{2af}(t). The time response determination unit 106 calculates at least one of a rise time, an overshoot amount, or a setting time, for example, based on the time response T_{2af}(t) to determine controllability for stabilization to a target value. A condition such as the rise time, the overshoot amount, or the setting time for determining controllability is appropriately set based on a requirement such as a required cycle time.

To apply the control parameter P_{1af} of the representative machine 11 to the same model machine 12 when it is determined that the time response has satisfied the condition, the time response determination unit 106 outputs a result of the determination, which indicates applicability, and the control parameter P_{1af} to the adjustment unit 140 of the same model machine 12 as a result of the check.

When it is determined that the time response does not satisfy the condition, on the other hand, the time response determination unit 106 outputs a result of the determination, which indicates that the control parameter P_{1af} of the representative machine 11 is not applicable to the same model machine 12, to the adjustment unit 140 of the same model machine 12 as a result of the check.

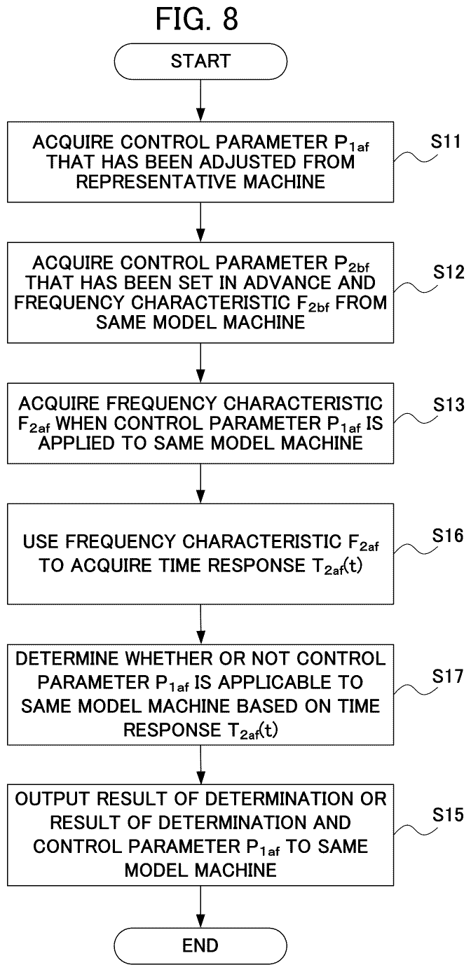

Next, operation of the application check device 10B according to the present embodiment will now be described herein with reference to a flowchart illustrated in FIG. 8. Since Steps S11 to S13 and S15 of the application check device 10B, which are illustrated in FIG. 8, are identical to those in the operation of the application check device 10, which are illustrated in FIG. 5, their descriptions are omitted. In FIG. 8, Step S14 illustrated in FIG. 5 is replaced with Steps S16 and S17.

At Step S16, the time response prediction unit 105 uses the frequency response F_{2af} to acquire the time response T_{2af}(t). Specifically, as described already, the time response prediction unit 105 acquires the frequency response F_{2af}, uses the frequency response F_{2af} to perform a mode analysis, and then performs a main analysis. A transfer function acquired through the main analysis is allowed to undergo inverse laplace transformation to acquire the time response T_{2af}(t). At Step S17, the time response determination unit 106 determines whether or not a result of the adjustment of the representative machine 11 is applicable to the same model machine 12 based on the time response T_{2af}(t) serving as a result of the prediction. In the present embodiment, as described already, the time response determination unit 106 calculates at least one of a rise time, an overshoot amount, or a setting time, for example, based on the time response T_{2af}(t) to determine controllability for stabilization to a target value.

According to the present embodiment described above, similar to the first embodiment, it is possible to check whether or not a result of an adjustment of a representative machine is applicable before being applied to another machine that is identical in model. In addition, according to the present embodiment, it is possible to guarantee, in the representative machine and a machine that is identical in model, controllability for stabilization to a target value at a level similar to that of the representative machine having undergone an adjustment.

### Fourth Embodiment

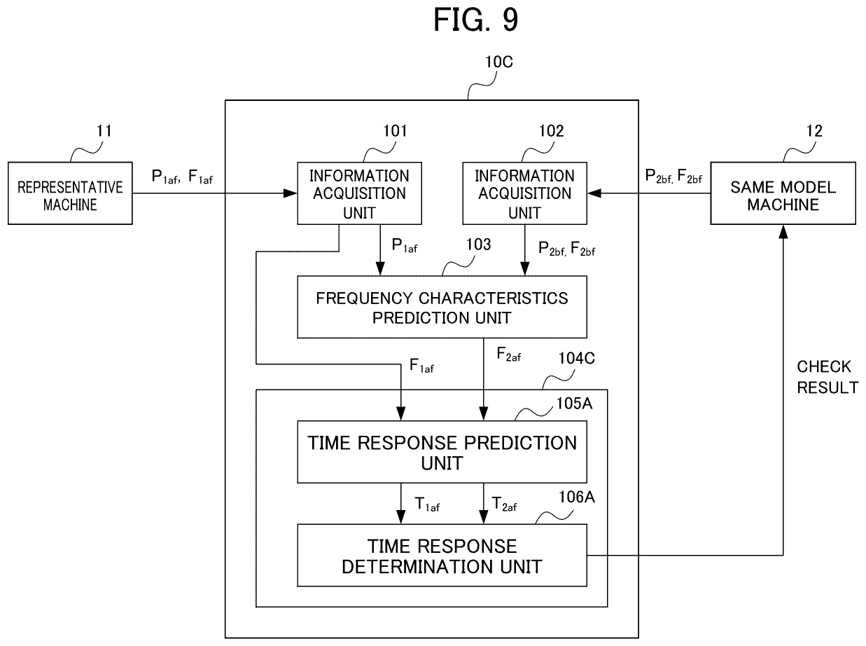

FIG. 9 is a block diagram illustrating a configuration of an application check device for adjustment result, according to a fourth embodiment of the present disclosure. In FIG. 9, like reference numerals designate identical components to the components illustrated in FIG. 7. In an application check device 10C according to the present embodiment, as illustrated in FIG. 9, the time response prediction unit 105 and the time response determination unit 106 according to the third embodiment are replaced with a time response prediction unit 105A and a time response determination unit 106A, respectively.

The time response prediction unit 105A utilizes the frequency response F_{2af} to predict the time response T_{2af}, acquires the frequency response Faf of the representative machine 11 when operated using the control parameter P_{1af} from the information acquisition unit 101, and utilizes the frequency response F_{1af} to predict the time response T_{1af}. The time response T_{1af} serves as a first time response, and the time response T_{2af} serves as a second time response.

The time response determination unit 106A compares the time response Traf and the time response T_{1af} with each other. The time response determination unit 106A calculates at least one (hereinafter referred to as an evaluation index) of a rise time, an overshoot amount, or a setting time, for example, based on each of the time response T_{2af} and the time response T_{1af}. Then, the time response determination unit 106A compares the evaluation index that has been calculated based on the time response T_{2af} and the evaluation index that has been calculated based on the time response T_{1af} with each other. Then, the time response determination unit 106A determines whether or not to apply the control parameter P_{1af} of the representative machine 11 to the same model machine 12 based on a result of the comparison. In below description, the description is given with reference to an example where the setting time serves as an evaluation index.

To apply the control parameter P_{1af} of the representative machine 11 to the same model machine 12 when it is determined that the setting time of the same model machine 12 is shorter than the setting time of the representative machine 11 or shorter than 90% of the setting time of the representative machine 11, for example, the time response determination unit 106A outputs a result of the determination, which indicates applicability, and the control parameter P_{1af} to the adjustment unit 140 of the same model machine 12 as a result of the check.

When it is determined that the setting time of the same model machine 12 is equal to or longer than the setting time of the representative machine 11 or equal to or longer than 90% of the setting time of the representative machine 11, on the other hand, the time response determination unit 106A outputs a result of the determination, which indicates that the control parameter P_{1af} of the representative machine 11 is not applicable to the same model machine 12, to the adjustment unit 140 of the same model machine 12 as a result of the check.

Operation of the application check device 10C according to the present embodiment differs, compared with the operation of the application check device 10B illustrated in FIG. 8, in those described below. At Step S16, the time response prediction unit 105A utilizes the frequency response F_{2af} to predict the time response T_{2af}, acquires the frequency response F_{1af} of the representative machine 11 when operated using the control parameter P_{1af} from the information acquisition unit 101, and utilizes the frequency response F_{1af} to predict the time response T_{1af}.

At Step S17, the time response determination unit 106A compares the time response T_{2af} and the time response T_{1af} with each other. The time response determination unit 106A calculates an evaluation index representing at least one of a rise time, an overshoot amount, or a setting time, for example, based on each of the time response T_{2af} and the time response Taf. Then, the time response determination unit 106A compares the evaluation index calculated based on the time response T_{2af} and the evaluation index calculated based on the time response T_{1af} with each other, and determines whether or not to apply the control parameter P_{1af} of the representative machine 11 to the same model machine 12 based on a result of the comparison.

According to the present embodiment described above, similar to the first embodiment, it is possible to check whether or not a result of an adjustment of a representative machine is applicable before being applied to another machine that is identical in model. In addition, according to the present embodiment, it is possible to guarantee, in the representative machine and a machine that is identical in model, that an evaluation index is satisfied at a level identical or similar to that of the representative machine having undergone an adjustment.

To achieve the functional blocks included in the application check device for adjustment result, according to each of the present embodiments, as described above, it is possible to achieve the application check device through hardware or software or a combination of hardware and software. Note herein that achievement through software means achievement when a computer reads and executes programs.

To achieve the functional blocks included in the application check device according to each of the present embodiments through pieces of hardware or software or a combination of hardware and software, specifically, the application check device includes an arithmetic processing unit such as a central processing unit (CPU). Furthermore, the application check device further includes an auxiliary storage device such as a hard disk drive (HDD) that stores programs for various types of control, including application software or an operating system (OS), and a main storage device such as a random access memory (RAM) that stores data that the arithmetic processing unit temporarily requires to execute the programs.

In the application check device, the arithmetic processing unit then reads the application software or the OS from the auxiliary storage device, deploys the read application software or the read OS into the main storage device, and performs arithmetic processing based on the application software or the OS. Furthermore, based on a result of this arithmetic processing, various types of hardware included in the devices are controlled. Thereby, the functional blocks according to the present embodiments are achieved.

It is possible to achieve the components included in the application check device through hardware including electronic circuits, for example. When the application check device is configured through hardware, it is possible to configure some or all of the functions of the components included in the application check device with, for example, an integrated circuit (IC) such as an application specific integrated circuit (ASIC), a gate array, a field programmable gate array (FPGA), or a complex programmable logic device (CPLD).

It is possible to use a non-transitory computer readable medium that varies in type to store the programs, and to supply the programs to a computer. Examples of the non-transitory computer readable medium include tangible storage media that vary in type. Examples of the non-transitory computer readable medium include magnetic recording media (for example, hard disk drive), magneto-optical recording media (for example, magneto-optical disc), compact disc read only memories (CD-ROM), compact disc-recordable (CD-R), compact disc-rewritable (CD-R/W), semiconductor memories (for example, mask ROM, programmable ROM (PROM), erasable PROM (EPROM), flash ROM, and random access memory (RAM)). Furthermore, the programs may be supplied to the computer via a transitory computer readable medium that varies in type.

Then, with the application check device and the application check method for adjustment result, according to the present disclosure, including the present embodiments, it is possible to check whether or not a result of an adjustment of a representative machine is applicable before being applied to another machine that is identical in model.

Although the foregoing embodiments represent preferable embodiments of the present invention, the scope of the present invention should not be limited to only the embodiments described above. Embodiments that have been variously changed without departing from the gist of the present invention are also implementable.

Regarding the embodiments described above, additional remarks described below are further disclosed.

### (Additional Remark 1)

An application check device for an adjustment result, includes: a first information acquisition unit (101) that acquires a first control parameter (Piaf), the first control parameter having been adjusted, of a first motor control unit (110) that drives an axis of a first machine (11); a second information acquisition unit (102) that acquires a second control parameter (P_{2bf}), the second control parameter being set in advance, of a second motor control unit (110) that drives an axis of a second machine (12) that is identical in model to the first machine and a first frequency response (F_{2bf}) of the second machine when operated using the second control parameter; a frequency responses prediction unit (103) that predicts a second frequency response (F_{2af}) of the second machine when the first control parameter is applied to the second motor control unit of the second machine based on the first control parameter, the second control parameter, and the first frequency response; and an adjustment result application check unit (104, 104A, 104B, 104C) that checks whether or not the first control parameter is applicable to the second motor control unit of the second machine using at least the second frequency response.

### (Additional Remark 2)

The application check device according to Additional Remark 1, in which the adjustment result application check unit (104) determines whether or not to apply the first control parameter (Piaf) to the second motor control unit (110) of the second machine (12) based on the second frequency response (F_{2af}) that the frequency responses prediction unit has predicted (103).

### (Additional Remark 3)

The application check device according to Additional Remark 1, in which the first information acquisition unit (101) acquires a third frequency response (F_{1af}) of the first machine (11) when operated using the first control parameter (P_{1af}), and the adjustment result application check unit (104A) compares the second frequency response (F_{2af}) and the third frequency response (F_{1af}) with each other, and determines whether or not to apply the first control parameter (Piaf) to the second motor control unit (110) of the second machine (12) based on a result of the comparison.

### (Additional Remark 4)

The application check device according to Additional Remark 1, in which the adjustment result application check unit (104B) includes: a time response prediction unit (105) that predicts a time response (T_{2af}) based on the second frequency response (F_{2af}); and a time response determination unit (106) that determines whether or not to apply the first control parameter (Piaf) to the second motor control unit (110) of the second machine (12) based on the time response that has been predicted.

### (Additional Remark 5)

The application check device according to Additional Remark 1, in which the first information acquisition unit (101) acquires a third frequency response (F_{1af}) of the first machine (11) when operated using the first control parameter (Piaf), and the adjustment result application check unit (104C) includes: a time response prediction unit (105A) that predicts a first time response (T_{1af}) based on the third frequency response (F_{1af}) and predicts a second time response (T_{2af}) based on the second frequency response (F_{2af}); and a time response determination unit (106A) that compares the first time response and the second time response with each other and determines whether or not to apply the first control parameter (Piaf) to the second motor control unit (110) of the second machine (12) based on a result of the comparison.

### (Additional Remark 6)

The application check device according to any one of Additional Remark 1 to 5, further including a frequency responses measurement unit that measures the first frequency response (F_{2bf}) of the second machine (12).

### (Additional Remark 7)

An application check method for an adjustment result, including causing a computer to execute: processing of acquiring a first control parameter (Piaf), the first control parameter having been adjusted, of a first motor control unit (110) that drives an axis of a first machine (11); processing of acquiring a second control parameter (P_{2bf}), the second control parameter being set in advance, of a second motor control unit (110) that drives an axis of a second machine (12) that is identical in model to the first machine and a first frequency response (F_{2bf}) of the second machine when operated using the second control parameter; processing of predicting a second frequency response (F_{2af}) of the second machine when the first control parameter is applied to the second motor control unit of the second machine based on the first control parameter, the second control parameter, and the first frequency response; and processing of checking whether or not the first control parameter is applicable to the second motor control unit of the second machine using at least the second frequency response.

### EXPLANATION OF REFERENCE NUMERALS

10, 10A, 10B, 10C Application check device for adjustment result
11 Representative machine
12 Same model machine
101 Information acquisition unit
102 Information acquisition unit
103 Frequency responses prediction unit
104, 104A, 104B, 104C Adjustment result application check unit
105, 105A Time response prediction unit
106, 106A Time response determination unit
110 Motor control unit
111 Subtracter
112 Speed control unit
113 Filter
114 Current control unit
120 Frequency generation unit
130 Frequency responses measurement unit
140 Adjustment unit

1. An application check device for an adjustment result, comprising:
a first information acquisition unit that acquires a first control parameter, the first control parameter having been adjusted, of a first motor control unit that drives an axis of a first machine;
a second information acquisition unit that acquires a second control parameter, the second control parameter being set in advance, of a second motor control unit that drives an axis of a second machine that is identical in model to the first machine and a first frequency response of the second machine when operated using the second control parameter;
a frequency responses prediction unit that predicts a second frequency response of the second machine when the first control parameter is applied to the second motor control unit of the second machine based on the first control parameter, the second control parameter, and the first frequency response; and
an adjustment result application check unit that checks whether or not the first control parameter is applicable to the second motor control unit of the second machine using at least the second frequency response.

2. The application check device according to claim 1, wherein the adjustment result application check unit determines whether or not to apply the first control parameter to the second motor control unit of the second machine based on the second frequency response that the frequency responses prediction unit has predicted.

3. The application check device according to claim 1, wherein
the first information acquisition unit acquires a third frequency response of the first machine when operated using the first control parameter, and
the adjustment result application check unit compares the second frequency response and the third frequency response with each other, and determines whether or not to apply the first control parameter to the second motor control unit of the second machine based on a result of the comparison.

4. The application check device according to claim 1, wherein
the adjustment result application check unit includes:
a time response prediction unit that predicts a time response based on the second frequency response; and
a time response determination unit that determines whether or not to apply the first control parameter to the second motor control unit of the second machine based on the time response that has been predicted.

5. The application check device according to claim 1, wherein
the first information acquisition unit acquires a third frequency response of the first machine when operated using the first control parameter, and
the adjustment result application check unit includes:
a time response prediction unit that predicts a first time response based on the third frequency response and predicts a second time response based on the second frequency response; and
a time response determination unit that compares the first time response and the second time response with each other and determines whether or not to apply the first control parameter to the second motor control unit of the second machine based on a result of the comparison.

6. The application check device according to claim 1, further comprising a frequency responses measurement unit that measures the first frequency response of the second machine.

7. An application check method for an adjustment result, comprising causing a computer to execute:
processing of acquiring a first control parameter, the first control parameter having been adjusted, of a first motor control unit that drives an axis of a first machine;
processing of acquiring a second control parameter, the second control parameter being set in advance, of a second motor control unit that drives an axis of a second machine that is identical in model to the first machine and a first frequency response of the second machine when operated using the second control parameter;
processing of predicting a second frequency response of the second machine when the first control parameter is applied to the second motor control unit of the second machine based on the first control parameter, the second control parameter, and the first frequency response; and
processing of checking whether or not the first control parameter is applicable to the second motor control unit of the second machine using at least the second frequency response.
